(19) United States
(12) Patent Application Publication
(10) Pub. No.: US 2024/0142850 A1
(43) Pub. Date: May 2, 2024

(54) SPATIAL LIGHT MODULATOR AND ELECTRONIC APPARATUS INCLUDING THE SAME

(71) Applicant: SAMSUNG ELECTRONICS CO., LTD, Suwon-si (KR)

(72) Inventors: Sunil KIM, Suwon-si (KR); Byunggil JEONG, Suwon-si (KR); Junghyun PARK, Suwon-si (KR); Minkyung LEE, Suwon-si (KR)

(73) Assignee: SAMSUNG ELECTRONICS CO., LTD., Suwon-si (KR)

(21) Appl. No.: 18/384,710

(22) Filed: Oct. 27, 2023

(30) Foreign Application Priority Data
Oct. 28, 2022 (KR) 10-2022-0141762

(51) Int. Cl. G02F 1/29

(52) U.S. Cl. CPC G02F 1/292

(57) ABSTRACT

Provided is a light modulating apparatus including a plurality of pixels, each pixel of the plurality of pixels being configured to steer incident light and operate as an on-pixel or an off-pixel, a spatial light modulator configured to modulate the incident light and emit the light at a predetermined steering angle, and a processor configured to apply different voltages respectively corresponding to steering angles of the on-pixel.

### CROSS-REFERENCE TO RELATED APPLICATION

This application is based on and claims priority under 35 U.S.C. § 119 to Korean Patent Application No. 10-2022-0141762, filed on Oct. 28, 2022, in the Korean Intellectual Property Office, the disclosure of which is incorporated by reference herein in its entirety.

### BACKGROUND

### 1. Field

Example embodiments of the present disclosure relate to a spatial light modulator capable of controlling the output phase of light, and an electronic apparatus including the spatial light modulator.

### 2. Description of Related Art

Advanced driving assistance systems (ADASs) having various functions have been commercialized. For example, an increasing number of vehicles is equipped with various functions, such as adaptive cruise control (ACC) for reducing the speed when there is a risk of collision and driving the vehicle within a set speed range when there is no risk of collision by recognizing the position and speed of other surrounding vehicles and an autonomous emergency braking (AEB) system that recognizes a vehicle in front and prevents a collision by automatically applying braking when there is a risk of collision and the driver does not respond or a response method is inappropriate. Furthermore, it is expected that vehicles capable of autonomous driving will be commercialized in the near future.

Accordingly, interest in optical measurement devices capable of providing information about the surroundings of a vehicle is growing. For example, a light detection and ranging (LiDAR) apparatus for vehicles may provide information on a distance, a relative speed, an azimuth angle, etc. with respect to an object in the vicinity of a vehicle by emitting a laser to a selected region in the vicinity of the vehicle and detecting the reflected laser. To this end, a LiDAR apparatus for vehicles needs a beam steering technology that enables steering of light to a desired region.

Beam steering methods may largely include mechanical methods and non-mechanical methods. For example, mechanical beam steering methods may include a method of rotating a light source, a method of rotating a mirror that reflects light, a method of moving a spherical lens in a direction perpendicular to the optical axis, etc. Furthermore, non-mechanical beam steering methods include a method using a semiconductor device and a method of electrically controlling the angle of reflected light by using a reflective phase array.

### SUMMARY

One or more example embodiments provide a spatial light modulator with a relatively high reliability and an electronic apparatus including the spatial light modulator.

Additional aspects will be set forth in part in the description which follows and, in part, will be apparent from the description, or may be learned by practice of example embodiments of the disclosure.

According to an aspect of an example embodiment, there is provided a light modulating apparatus including a plurality of pixels, each pixel of the plurality of pixels being configured to steer incident light and operate as an on-pixel or an off-pixel, a spatial light modulator configured to modulate the incident light and emit the light at a predetermined steering angle, and a processor configured to apply different voltages respectively corresponding to steering angles of the on-pixel.

The processor may be further configured to apply a first voltage corresponding to a first steering angle of the on-pixel, or apply a second voltage corresponding to a second steering angle of the on-pixel.

Based on the first steering angle being less than the second steering angle, the first voltage may be less than the second voltage.

The predetermined steering angle may be obtained based on a pitch of the on-pixel and the off-pixel.

The pitch may be obtained based on a first group including a plurality of on-pixels and a second group including a plurality of off-pixels.

According to another aspect of an example embodiment, there is provided a spatial light modulator including a first reflective layer, a cavity layer on the first reflective layer, a second reflective layer on the cavity layer, the second reflective layer including a plurality of grating structures spaced apart from each other, a plurality of pixels each including the first reflective layer, the cavity layer, and the second reflective layer, each pixel of the plurality of pixels operating as an on-pixel or an off-pixel, and a processor configured to modulate incident light and emit the modulated light at a predetermined steering angle, and apply different voltages respectively corresponding to steering angles of the on-pixel.

The processor may be further configured to apply a first voltage corresponding to a first steering angle of the on-pixel, or apply a second voltage corresponding to a second steering angle of the on-pixel.

Based on the first steering angle being less than the second steering angle, the first voltage may be less than the second voltage.

The predetermined steering angle may be obtained based on a pitch of the on-pixel and the off-pixel.

The pitch may be obtained based on a first group including a plurality of on-pixels and a second group including a plurality of off-pixels.

Each grating of the plurality of grating structures may include silicon (Si).

Each grating of the plurality of grating structures may include at least one of a PIN structure, a NIN structure, or a PIP structure.

The first reflective layer may be a distributed Bragg reflective layer.

The first reflective layer may include layers including two of silicon (Si), silicon nitride (Si₃N₄), silicon oxide (SiO₂), and titanium oxide (TiO₂) that are alternately stacked.

The cavity layer may include silicon oxide (SiO₂).

A reflectivity of the first reflective layer may be different from a reflectivity of the second reflective layer.

A difference between the first voltage and the second voltage may be greater than or equal to 2 V and less than or equal to 8 V.

An absolute value of the first voltage may be different from an absolute value of the second voltage.

A difference between the first steering angle and the second steering angle may be greater than or equal to 1 degree and less than or equal to 30 degrees.

According to yet another aspect of an example embodiment, there is provided an electronic apparatus including a light source configured to emit light, a spatial light modulator configured to adjust a propagation direction of the light emitted from the light source and emit the light to an object, and a light detector configured to detect light reflected from the object, wherein the spatial light modulator includes a first reflective layer, a cavity layer on the first reflective layer, a second reflective layer on the cavity layer, the second reflective layer including a plurality of grating structures spaced apart from each other, a plurality of pixels, each pixel of the plurality of pixels including the first reflective layer, the cavity layer, and the second reflective layer, and operating as an on-pixel or an off-pixel, and a processor configured to modulate incident light, and emit the modulated light at a predetermined steering angle, and apply different voltages respectively corresponding to steering angles of the on-pixel.

The processor may be further configured to apply a first voltage corresponding to a first steering angle of the on-pixel, or apply a second voltage corresponding to a second steering angle of the on-pixel.

Based on the first steering angle being less than the second steering angle, the first voltage may be less than the second voltage.

The predetermined steering angle may be obtained based on a pitch of the on-pixel and the off-pixel.

The pitch may be obtained based on a first group including a plurality of on-pixels and a second group including a plurality of off-pixels.

A difference between the first voltage and the second voltage may be greater than or equal to 2 V and less than or equal to 8 V.

An absolute value of the first voltage may be different from an absolute value of the second voltage.

A difference between the first steering angle and the second steering angle may be greater than or equal to 1 degree and less than or equal to 30 degrees.

### BRIEF DESCRIPTION OF THE DRAWINGS

The above and other aspects, features, and advantages of certain example embodiments of the disclosure will be more apparent from the following description taken in conjunction with the accompanying drawings, in which:

FIG. 1 is a block diagram illustrating a light modulating apparatus according to an example embodiment;

FIG. 2 is a conceptual cross-sectional view of a spatial light modulator according to an example embodiment;

FIG. 3A is a cross-sectional view showing grating structures of a first pixel in FIG. 1;

FIG. 3B is a cross-sectional view of the grating structures of FIG. 1 from another direction;

FIGS. 4A, 4B, and 4C are diagrams illustrating changes in a pitch of a pixel according to an example embodiment;

FIG. 5 is a diagram illustrating a change in a steering angle according to a change in a pitch of a pixel according to an example embodiment;

FIG. 6 is a diagram illustrating a change in an applied voltage according to the change in the steering angle of FIG. 5;

FIG. 7 is a block diagram showing the structure of a light detection and ranging (LiDAR) apparatus according to an example embodiment;

FIG. 8 is a block diagram showing the structure of a LiDAR apparatus according to another example embodiment; and

FIGS. 9A and 9B are conceptual views showing a case in which a LiDAR apparatus according to an example embodiment is applied to a vehicle.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the embodiments are merely described below, by referring to the figures, to explain aspects.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, various embodiments are described in detail with reference to the accompanying drawings. In the accompanying drawings, like reference numerals refer to like elements throughout. The thickness or size of each layer illustrated in the drawings may be exaggerated for convenience of explanation and clarity. Meanwhile, embodiments to be described are merely examples, and various modifications may be made from such embodiments.

When an expression “above” or “on” may include not only “directly on/under/at left/right contactually”, but also “on/under/at left/right contactlessly”. Singular forms include plural forms unless apparently indicated otherwise contextually. It will be further understood that when a portion is referred to as “comprises” a component, the portion may not exclude another component but may further include another component unless stated otherwise.

The use of the term “the” and similar referents in the context of describing the disclosure are to be construed to cover both the singular and the plural. The operations of all methods described herein may be performed in any suitable order unless otherwise indicated herein or otherwise clearly contradicted by context, and embodiments are not limited to the described order of the operations.

Moreover, the terms “portion”, “module,” etc. refer to a unit processing at least one function or operation, and may be implemented by a hardware, a software, or a combination thereof.

The connecting lines, or connectors shown in the various figures presented are intended to represent functional relationships and/or physical or logical couplings between the various elements, and thus it should be noted that many alternative or additional functional relationships, physical connections or logical connections may be present in a practical device.

The use of any and all examples, or exemplary language provided herein, is intended merely to better illuminate technical ideas and does not pose a limitation on the scope of embodiments unless otherwise claimed.

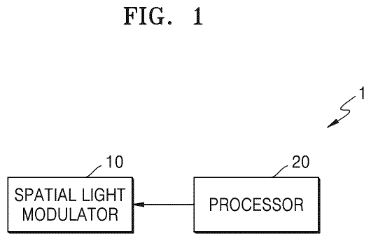

FIG. 1 is a block diagram illustrating a light modulating apparatus according to an example embodiment.

As shown in FIG. 1, a light modulating apparatus 1 may include a spatial light modulator 10 that modulates an incident light and a processor 20 that controls the spatial light modulator 10.

The spatial light modulator 10 according to an example embodiment may modulate a phase of the incident light in order to adjust a traveling direction of an output light to be directed in a desired direction.

The processor 20 may provide a phase profile to the spatial light modulator 10 to adjust the traveling direction of the output light. Also, the processor 20 may additionally provide a control signal to control heat generated by the spatial light modulator 10 to the spatial light modulator 10.

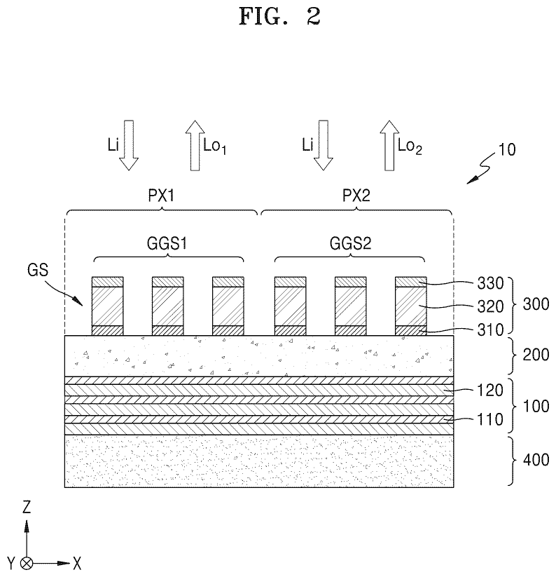

FIG. 2 is a conceptual cross-sectional view of a spatial light modulator according to an example embodiment.

Referring to FIG. 2, the spatial light modulator 10 may include a first reflective layer 100, a cavity layer 200 arranged on the first reflective layer 100, and a second reflective layer 300 arranged on the cavity layer 200.

The spatial light modulator 10 may output light by modulating the phase of incident light Li. The spatial light modulator 10 may include a plurality of pixels. The pixels may include, for example, a first pixel PX1 and a second pixel PX2. A pixel may refer to the smallest unit that is independently driven in the spatial light modulator 10 or a basic unit that independently modulates the phase of light. A pixel may include one or more grating structures GS forming the second reflective layer 300. FIG. 2 illustrates an example of a structure including two pixels. A pitch between the grating structures GS may be smaller than a wavelength of a modulated light. The length of one side of each of the first pixel PX1 and the second pixel PX2 may be, for example, about 3 μm to about 300 μm.

The spatial light modulator 10 may further include a substrate 400 that supports the first reflective layer 100 opposite to the cavity layer 200. The substrate 400 may be formed of an insulating material. For example, the substrate 400 may be a transparent substrate, for example, a silicon substrate or a glass substrate, that may transmit light.

The first reflective layer 100 may be a distributed Bragg reflector. For example, the first reflective layer 100 may include a first layer 110 and a second layer 120 having different refractive indexes. The first layer 110 and the second layer 120 may be alternately and repeatedly stacked. Due to a difference in the refractive index between the first layer 110 and the second layer 120, light may be reflected at an interface of each layer and the reflected light may cause interference. The first layer 110 or the second layer 120 may include silicon (Si), silicon nitride (Si₃N₄), silicon oxide (SiO₂), titanium oxide (TiO₂), etc. For example, while the first layer 110 may be formed of silicon, the second layer 120 layer may be formed of SiO₂. By adjusting the thickness and/or stack number of the first layer 110 and the second layer 120, the light reflectivity of the first reflective layer 100 may be designed.

The first reflective layer 100 may be a structure other than the distributed Bragg reflector, and may include, for example, a metal reflective layer having one metal surface.

The cavity layer 200 is a region in which the incident light resonates, and may be disposed between the first reflective layer 100 and the second reflective layer 300.

The cavity layer 200 may include, for example, SiO₂. A resonance wavelength may be determined according to the thickness of the cavity layer 200. As the thickness of the cavity layer 200 increases, the resonance wavelength of light may increase, and as the thickness of the cavity layer 200 decreases, the resonance wavelength of light may decrease.

The second reflective layer 300 may be designed to appropriately perform a reflection function of reflecting light of a specific wavelength and a phase modulation function of modulating the phase of output light.

The second reflective layer 300 may include the grating structures GS that are arranged to be spaced apart from each other at certain intervals. The thickness, width, and pitch of the grating structures GS may be less than the wavelength of light that is modulated by the spatial light modulator 10. The reflectivity of light that is modulated may be increased by adjusting the thickness, width, pitch, etc. of the grating structures GS. The reflectively of the second reflective layer 300 may be different from that of the first reflective layer 100, and the reflectivity of the second reflective layer 300 may be less than that of the first reflective layer 100.

The incident light Li on the spatial light modulator 10 may be transmitted by the second reflective layer 300, and is propagated to the cavity layer 200. Then the incident light Li is reflected by the second reflective layer 300. Then, the light is trapped and resonated in the cavity layer 200 by the first reflective layer 100 and the second reflective layer 300, and then output through the second reflective layer 300. Output light Lo₁ and Lo₂ may have a specific phase, and the phase of the output light Lo₁ and Lo₂ may be controlled by the refractive index of the second reflective layer 300. The traveling direction light may be determined by a relationship of the phase of light output from adjacent pixels. For example, when the phase of the output light Lo₁ of the first pixel PX1 and the phase of the output light Lo₂ of the second pixel PX2 are different from each other, the traveling direction of light may be determined by the interaction of the output light Lo₁ and Lo₂.

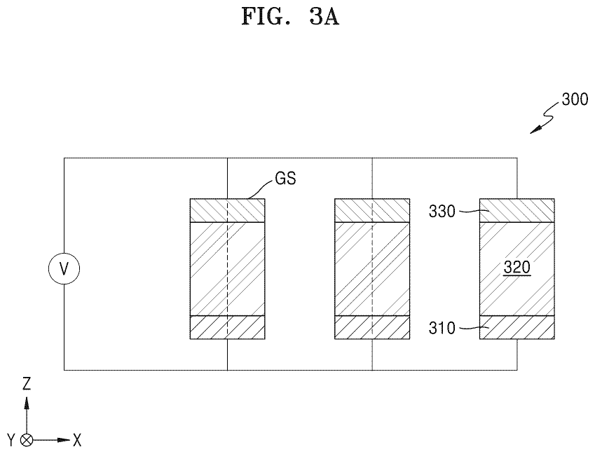

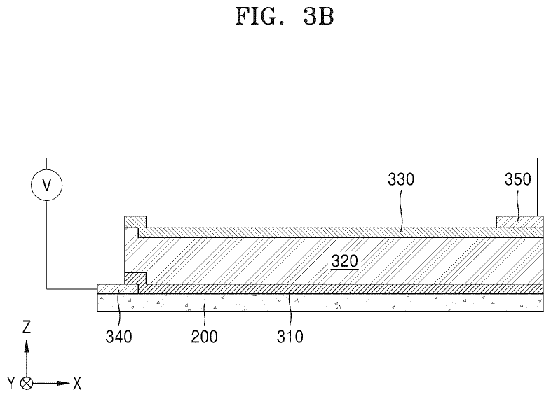

FIG. 3A is a cross-sectional view showing the grating structures GS of the first pixel PX1 of FIG. 1. FIG. 3B is a cross-sectional view of the grating structures GS of FIG. 1 from another direction. Referring to FIG. 3A, the grating structures GS may include a first doped semiconductor layer 310, an intrinsic semiconductor layer 320, and a second doped semiconductor layer 330. For example, the first doped semiconductor layer 310 may be an n-type semiconductor layer, the second doped semiconductor layer 330 may be a p-type semiconductor layer, and the grating structures GS may be a PIN diode.

The first doped semiconductor layer 310 may be a silicon layer containing a group 5 element, for example, phosphorus (P) or arsenic (As), as impurities. The concentration of impurities included in the first doped semiconductor layer 310 may be about 10¹⁵ to 10²¹ cm⁻³. The intrinsic semiconductor layer 320 may be a silicon layer that does not include impurities. The second doped semiconductor layer 330 may be a silicon layer containing a group 3 element, for example, boron (B), as impurities. The concentration of impurities included in the second doped semiconductor layer 330 may be about 10¹⁵ to 10²¹ cm⁻³.

When a voltage is applied between the first doped semiconductor layer 310 and the second doped semiconductor layer 330, a current flows in a direction from the first doped semiconductor layer 310 to the second doped semiconductor layer 330. Heat is generated in the grating structures GS due to the current, and thus the refractive indexes of the grating structures GS may be changed by the heat. When the refractive indexes of the grating structures GS are changed, the phase of light output from the first pixel PX1 and the second pixel PX2 may be changed. Accordingly, the traveling direction of the light output from the spatial light modulator 10 may be controlled by adjusting the amount of a voltage V applied to each of the first pixel PX1 and the second pixel PX2.

FIG. 3B is a cross-sectional view of the grating structures GS in another direction (Y direction). Referring to FIG. 3B, the spatial light modulator 10 may include a first electrode 340 and a second electrode 350 that may apply a voltage to the grating structures GS. The first electrode 340 may be in contact with one end of the first doped semiconductor layer 310, and the second electrode 350 may be in contact with one end of the second doped semiconductor layer 330. The second electrode 350 may be in contact with an end portion arranged in the Y direction opposite to the end portion that is in contact with the first electrode 340. The first electrode 340 may be arranged on an upper portion of the cavity layer 200, and may be a common electrode that applies a common voltage to all pixels included in the spatial light modulator 10. The second electrode 350 may be a pixel electrode that may apply a different voltage to each pixel.

Although FIGS. 3A and 3B illustrate the grating structures GS in a PIN structure, embodiments are not limited thereto. The grating structures GS may have an NIN structure or a PIP structure. For example, the first doped semiconductor layer 310 and the second doped semiconductor layer 330 may be n-type semiconductor layers or p-type semiconductor layers.

The spatial light modulator 10 according to an example embodiment may be driven according to a phase profile provided by the processor 20 to steer light in various directions. The phase profile may be a binary electrical signal to which an on-signal or an off-signal is applied for each pixel.

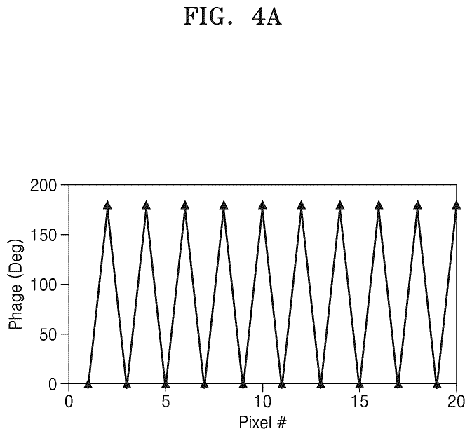

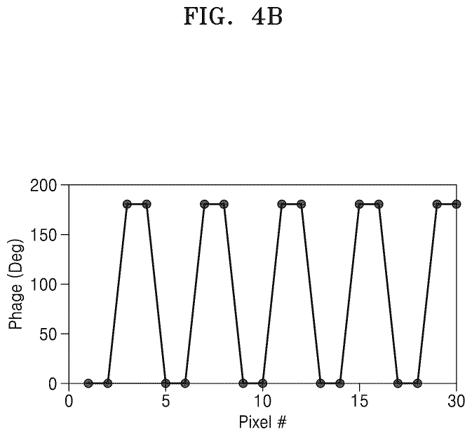

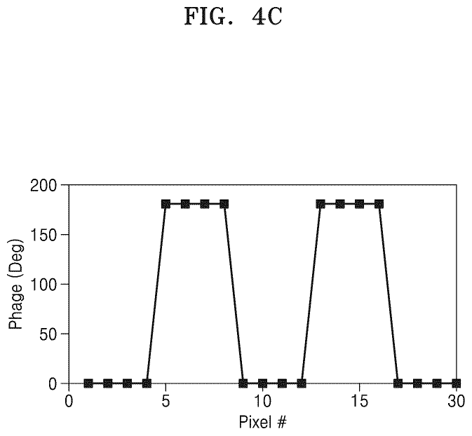

FIGS. 4A to 4C are diagrams illustrating changes in a pitch of a pixel according to an example embodiment.

Referring to FIGS. 4A to 4C, on-pixels having a phase of 180 degrees and off-pixels having a phase of 0 degrees are grouped together, which may be one pitch. This pitch may change according to the number of on-pixels and off-pixels included in one group. As the pitch including on-pixels and off-pixels increases, a steering angle may decrease, and as the pitch including on-pixels and off-pixels decreases, the steering angle may increase, as described below.

According to an example embodiment, current may flow through a grating structure GS included in a pixel (on-pixel) to which an on-signal is applied, and heat is generated in the grating structure GS, and thus, a refractive index of the grating structure GS may change. Because current does not flow through the grating structure GS included in a pixel (off-pixel) to which an off-signal is applied, the refractive index of the grating structures GS should not change.

However, because heat generated in the on-pixel is transferred to the off-pixel, the refractive index of the grating structure GS included in the off-pixel may also change. This heat transfer phenomenon and a phenomenon in which heat is generated according to the application of a voltage and affects pixels positioned adjacent to each other is referred to as crosstalk. The heat may be transferred to adjacent pixels through a material connecting the pixels, for example, the first reflective layer 100 and the cavity layer 200. Thus, because the refractive index of the off-pixel also changes by the on-signal, stable pixel driving of the spatial light modulator 10 may be difficult.

Therefore, it is necessary to reduce the transfer of heat generated in units of pixels to other pixels. In addition, heat generated from the spatial light modulator 10 needs to be removed for fast steering of light.

When the same voltage is applied to pixels at all steering angles, crosstalk caused by heat generated from the substrate 400 causes a phase change according to a distance between pixels. A large steering angle increases the distance between the on-pixel and off-pixel, which reduces crosstalk, and thus, a phase larger than a phase of 180 degrees required for the pixel is implemented. A small steering angle reduces the distance between the pixels, and thus, a phase smaller than the required phase is implemented. For this reason, when the same voltage is applied to all pixels at all steering angles, there is a disadvantage that a side mode suppression ratio (SMSR) decreases. A spatial light modulator and an electronic device including the spatial light modulator need to secure a relatively high SMSR. Therefore, a decrease in the SMSR may be a disadvantage, which may be solved by applying different voltages according to steering angles, as described below.

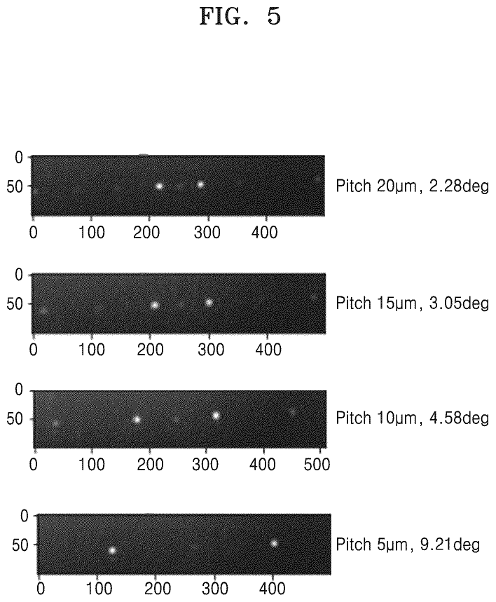

FIG. 5 is a diagram illustrating a change in a steering angle according to a change in a pitch of a pixel according to an example embodiment.

Referring to FIG. 5, as the pitch increases, the steering angle deg may decrease. Various steering angles may be secured by changing the pitch. The pitch may be determined by a first group including a plurality of on-pixels and a second group including a plurality of off-pixels. Different steering angles may be determined with respect to the first group and the second group, and different voltages may be applied to obtain the maximum SMSR according to different steering angles.

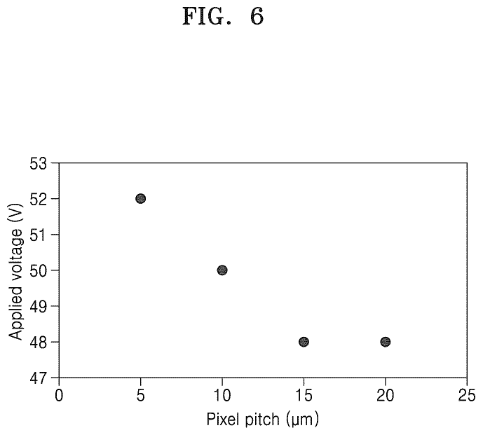

FIG. 6 is a diagram illustrating a change in applied voltage according to a change in a steering angle of FIG. 5.

FIG. 6 illustrates an applied voltage for obtaining the maximum SMSR according to a change in a pitch according to on-pixel and off-pixel. The steering angle may be changed by changing the number and distance of on-pixels and off-pixels included in one group. An applied voltage necessary for securing the maximum SMSR according to various steering angles may be obtained.

As the steering angle decreases as the distance between pixels increases, a lower voltage may be applied to obtain a higher SMSR. As the steering angle increases as the distance between pixels decreases, a relatively higher voltage may be applied to obtain a higher SMSR.

A beam steering device and a spatial light modulator having a relatively high SMSR at all steering angles may be obtained by applying different voltages according to changes in the steering angles, and thus, power consumption may be reduced.

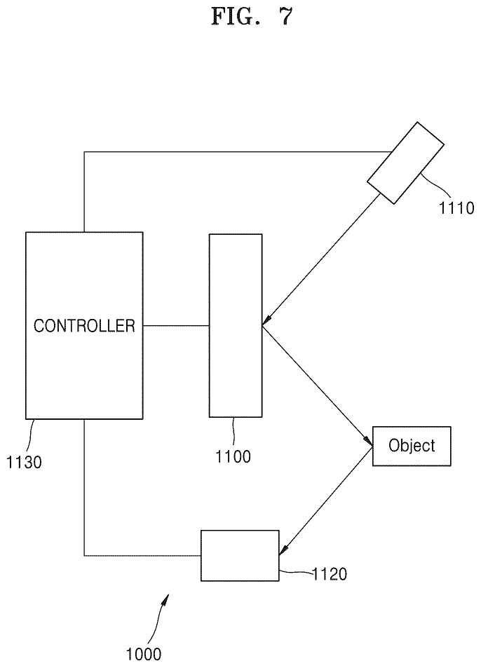

FIG. 7 is a block diagram showing the structure of a LiDAR apparatus according to an example embodiment.

Referring to FIG. 7, a LiDAR apparatus 1000 according to an example embodiment may include a light source 1110 that may emit light, a spatial light modulator 1100 that may control a traveling direction of incident light from the light source 1110, a photodetector 1120 that may detect light emitted from the spatial light modulator 1100 and reflected from an object, and a controller 1130 that may control the spatial light modulator 1100.

The light source 1110 may include, for example, a light source that may emit visible light or a laser diode (LD) or light-emitting diode (LED) that may emit a near infrared ray of about 800 nm to about 1700 nm band.

The spatial light modulator 1100 may include the spatial light modulators 10, 10a, 10b, 10c, and 10d described above. The spatial light modulator 1100 may control the traveling direction of light by modulating the phase of light for each pixel.

The controller 1130 may control the operations of the spatial light modulator 1100, the light source 1110, and the photodetector 1120. For example, the controller 1130 may control the on/off operation of the light source 1110 and the photodetector 1120, and the beam scanning operation of the spatial light modulator 1100. Furthermore, the controller 1130 may calculate information about the object on the basis of a measurement result of the photodetector 1120.

The controller 1130 may include one or more processor that may be physically implemented by analog and/or digital circuits including one or more of a logic gate, an integrated circuit, a microprocessor, a microcontroller, a memory circuit, a passive electronic component, an active electronic component, an optical component, and the like, and may be driven by firmware and software configured to perform the functions or operations described herein.

The LiDAR apparatus 1000 may periodically emit light with respect to many surrounding regions, by using the spatial light modulator 1100, to acquire information about objects therearound at a plurality of locations.

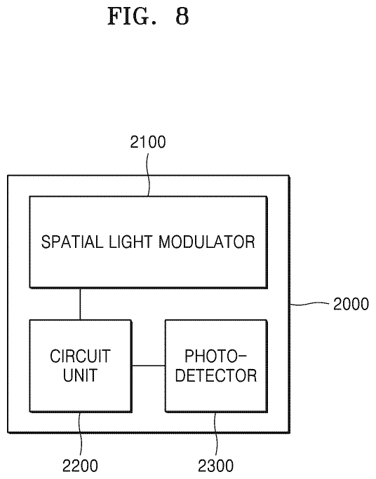

FIG. 8 is a block diagram showing the structure of a LiDAR apparatus according to another example embodiment.

Referring to FIG. 8, a LiDAR apparatus 2000 may include a spatial light modulator 2100 and a photodetector 2300 for detecting light that has a traveling direction controlled by the spatial light modulator 2100 and is reflected by an object. The LiDAR apparatus 2000 may further include a circuit unit 2200 connected to the spatial light modulator 2100 and/or the photodetector 2300. The circuit unit 2200 may include an operating unit for acquiring and operating data, a driving unit, a controller, etc. Furthermore, the circuit unit 2200 may further include a power unit, a memory, etc.

The LiDAR apparatus 2000 of FIG. 8 is illustrated as including the spatial light modulator 2100 and the photodetector 2300 in one device, however, embodiments are not limited thereto. For example, the spatial light modulator 2100 and the photodetector 2300 may be separately provided in separate devices, not provided in one device. Furthermore, the circuit unit 2200 may be connected to the spatial light modulator 2100 or the photodetector 2300, not in a wired manner, but in a wireless communication manner.

The above-described LiDAR apparatuses may be a phase-shift type apparatus or a time-of-flight (TOF) type apparatus.

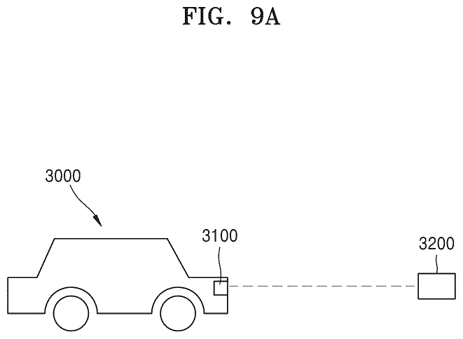

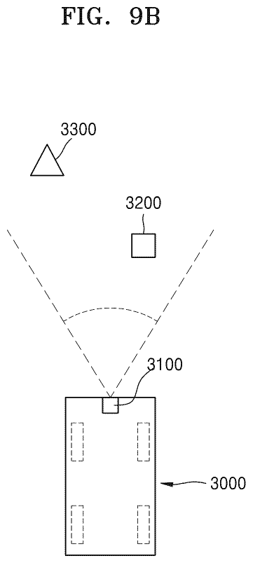

FIGS. 9A and 9B are conceptual views showing a case in which a LiDAR apparatus according to an example embodiment is applied to a vehicle. FIG. 9A is a view when viewed from the side of the vehicle, and FIG. 9B is a plan view of FIG. 9A.

Referring to FIG. 9A, a LiDAR apparatus 3100 may be applied to the vehicle 3000, and information about an object 3200 may be acquired by using the LiDAR apparatus 3100. The vehicle 3000 may be a vehicle having an autonomous function. An object or a human, that is, the object 3200, located in a direction in which the vehicle 3000 drives may be detected by using the LiDAR apparatus 3100. Furthermore, a distance to the object 3200 may be measured by using information such as a time difference between a transmitting signal and a detection-signal. Furthermore, as illustrated in FIG. 9B, information about the object 3200 located nearby and an object 3300 located remotely, which are within a scan range, may be acquired.

The light modulating apparatus according to an example embodiment includes a plurality of pixels for steering incident light, each of the plurality of pixels operating as an on-pixel or an off-pixel, a spatial light modulator modulating incident light to emit the light at a specific steering angle, and a processor applying different voltages corresponding to steering angles of on-pixels.

A reduction in an SMSR may be prevented and the maximum SMSR may be obtained by applying different voltages according to steering angles of on-pixels.

While the spatial light modulator and the electronic apparatus including the same described above have been described with reference to the embodiments described in the drawings, it will be understood by those of ordinary skill in the art that various modifications and equivalent other embodiments are possible therefrom. Therefore, the example embodiments should be considered in a descriptive sense rather than a restrictive sense. The scope of the present specification is not described above, but in the claims, and all the differences in a range equivalent thereto should be interpreted as being included.

Although example embodiments have been described above, these are merely examples and various changes may be made therefrom by those of ordinary skill in the art.

It should be understood that example embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims and their equivalents.

What is claimed is:

1. A light modulating apparatus comprising:
a plurality of pixels, each pixel of the plurality of pixels being configured to steer incident light and operate as an on-pixel or an off-pixel;
a spatial light modulator configured to modulate the incident light and emit the light at a predetermined steering angle; and
a processor configured to apply different voltages respectively corresponding to steering angles of the on-pixel.

2. The light modulating apparatus of claim 1, wherein the processor is further configured to:
apply a first voltage corresponding to a first steering angle of the on-pixel; or
apply a second voltage corresponding to a second steering angle of the on-pixel.

3. The light modulating apparatus of claim 2, wherein, based on the first steering angle being less than the second steering angle, the first voltage is less than the second voltage.

4. The light modulating apparatus of claim 1, wherein the predetermined steering angle is obtained based on a pitch of the on-pixel and the off-pixel.

5. The light modulating apparatus of claim 4, wherein the pitch is obtained based on a first group comprising a plurality of on-pixels and a second group comprising a plurality of off-pixels.

6. A spatial light modulator comprising:
a first reflective layer;
a cavity layer provided on the first reflective layer;
a second reflective layer provided on the cavity layer, the second reflective layer comprising a plurality of grating structures spaced apart from each other;
a plurality of pixels, each pixel of the plurality of pixels comprising the first reflective layer, the cavity layer, and the second reflective layer, and being configured to operate as an on-pixel or an off-pixel; and
a processor configured to modulate incident light and emit the modulated light at a predetermined steering angle, and apply different voltages respectively corresponding to steering angles of the on-pixel.

7. The spatial light modulator of claim 6, wherein the processor is further configured to:
apply a first voltage corresponding to a first steering angle of the on-pixel; or
apply a second voltage corresponding to a second steering angle of the on-pixel.

8. The spatial light modulator of claim 7, wherein, based on the first steering angle being less than the second steering angle, the first voltage is less than the second voltage.

9. The spatial light modulator of claim 6, wherein the predetermined steering angle is obtained based on a pitch of the on-pixel and the off-pixel.

10. The spatial light modulator of claim 9, wherein the pitch is obtained based on a first group comprising a plurality of on-pixels and a second group comprising a plurality of off-pixels.

11. The spatial light modulator of claim 6, wherein each grating of the plurality of grating structures includes silicon.

12. The spatial light modulator of claim 6, wherein each grating of the plurality of grating structures comprises at least one of a PIN structure, a NIN structure, ora PIP structure.

13. The spatial light modulator of claim 6, wherein the first reflective layer is a distributed Bragg reflective layer.

14. The spatial light modulator of claim 6, wherein the first reflective layer comprises layers comprising two of silicon (Si), silicon nitride (Si₃N₄), silicon oxide (SiO₂), and titanium oxide (TiO₂), and the layers are alternately stacked.

15. The spatial light modulator of claim 6, wherein the cavity layer comprises silicon oxide (SiO₂).

16. The spatial light modulator of claim 6, wherein a reflectivity of the first reflective layer is different from a reflectivity of the second reflective layer.

17. The spatial light modulator of claim 7, wherein a difference between the first voltage and the second voltage is greater than or equal to 2 V and less than or equal to 8 V.

18. The spatial light modulator of claim 7, wherein an absolute value of the first voltage is different from an absolute value of the second voltage.

19. The spatial light modulator of claim 7, wherein a difference between the first steering angle and the second steering angle is greater than or equal to 1 degree and less than or equal to 30 degrees.

20. An electronic apparatus comprising:
a light source configured to emit light;
a spatial light modulator configured to adjust a propagation direction of the light emitted by the light source and emit the light to an object; and
a light detector configured to detect light reflected from the object,
wherein the spatial light modulator comprises:
a first reflective layer;
a cavity layer on the first reflective layer;
a second reflective layer on the cavity layer, the second reflective layer comprising a plurality of grating structures spaced apart from each other;
a plurality of pixels, each pixel of the plurality of pixels comprising the first reflective layer, the cavity layer, and the second reflective layer, and operating as an on-pixel or an off-pixel; and
a processor configured to:
modulate incident light,
emit the modulated light at a predetermined steering angle, and apply different voltages respectively corresponding to steering angles of the on-pixel.

21. The electronic apparatus of claim 20, wherein the processor is further configured to:
apply a first voltage corresponding to a first steering angle of the on-pixel; or
apply a second voltage corresponding to a second steering angle of the on-pixel.

22. The electronic apparatus of claim 21, wherein, based on the first steering angle being less than the second steering angle, the first voltage is less than the second voltage.

23. The electronic apparatus of claim 20, wherein the predetermined steering angle is obtained based on a pitch of the on-pixel and the off-pixel.

24. The electronic apparatus of claim 23, wherein the pitch is obtained based on a first group comprising a plurality of on-pixels and a second group comprising a plurality of off-pixels.

25. The electronic apparatus of claim 21, wherein a difference between the first voltage and the second voltage is greater than or equal to 2 V and less than or equal to 8 V.

26. The electronic apparatus of claim 21, wherein an absolute value of the first voltage is different from an absolute value of the second voltage.

27. The electronic apparatus of claim 21, wherein a difference between the first steering angle and the second steering angle is greater than or equal to 1 degree and less than or equal to 30 degrees.
